(19) United States
(12) Patent Application Publication
(10) Pub. No.: US 2019/0392446 A1
(43) Pub. Date: Dec. 26, 2019

(54) COMPUTER SYSTEM AND COMPUTER-IMPLEMENTED METHOD FOR AUTHENTICATING A CARD-NOT-PRESENT TRANSACTION

(71) Applicant: MASTERCARD ASIA/PACIFIC PTE. LTD., Singapore (SG)

(72) Inventors: Weiming Ma, Singapore (SG); Jiaming Li, Singapore (SG); Rasika Chandana Karunapala, Singapore (SG)

(73) Assignee: MASTERCARD ASIA/PACIFIC PTE. LTD., Singapore (SG)

(21) Appl. No.: 16/410,453

(22) Filed: May 13, 2019

(30) Foreign Application Priority Data
Jun. 26, 2018 (SG) 10201805517R

(51) Int. Cl. G06Q 20/40; H04L 29/06; G06Q 20/38

(52) U.S. Cl. CPC G06Q 20/409; H04L 63/0884; G06Q 2220/00; G06Q 20/3829; H04L 2463/082; H04L 63/0435

(57) ABSTRACT

A payment network system for authenticating a card-not-present transaction comprising an authentication server, the authentication server comprising at least a first computer processor and a first data storage device, the first data storage device comprising instructions operative by the first computer processor to: (i) receive an authentication request comprising a payment amount associated with the card-not-present transaction, a customer account identifier and a preferred mode of authentication, and (ii) query a payment network database for a customer device identifier associated with the preferred mode of authentication and the customer account identifier, (iii) identify a device service provider server associated with the customer device identifier; (iv) transmit a request for authorisation to proceed with the card-not-present transaction; (v) receive, from the device service provider server, and a response for authorisation indicating if the card-not-present transaction is authorised.

### FIELD OF THE INVENTION

The present invention relates to a computer system and computer-implemented method for authenticating a card-not-present transaction. In particular, the invention relates to authenticating a card-not-present transaction using a two-factor authentication.

### BACKGROUND OF THE INVENTION

Card-not-present transactions, such as e-commerce transactions and mobile payments, are gaining popularity in recent years as a result of the convenience they bring to customers by way of enabling the customers to make payments or purchases at anytime and anywhere. Nonetheless, given the physical absence of a payment card inherent in a card-not-present transaction, authentication of a customer for the card-not-present transaction has to be performed using other means to ensure that the card-not-present transaction is made legitimately by the rightful customer (e.g. card owner) to minimise fraud.

At present, a 3D secure (3DS) process is often implemented in card-not-present transactions to enhance their security. In a typical 3DS payment transaction, a one-time-password (OTP) in the form of a Short Message Service (SMS) is used to authenticate a customer before the payment transaction can be authorised. However, the use of an OTP in authenticating a customer is cumbersome and cost-ineffective. Firstly, an OTP is required to be generated and sent to a customer for each card-not-present transaction, which takes up resources and increases transaction processing time. Secondly, the use of a SMS service incurs maintenance and infrastructure costs.

It is therefore an aim of the present invention to provide a computer system and computer-implemented method to provide a cost-effective and secure way to authenticate a card-not-present transaction.

### SUMMARY OF THE INVENTION

In accordance with a first aspect of the present invention, there is provided a payment network system for authenticating a card-not-present transaction. The system comprising:

an authentication server comprising at least a first computer processor and a first data storage device, the first data storage device comprising instructions operative by the first computer processor to:
receive, from an issuer server, an authentication request comprising a payment amount associated with the card-not-present transaction, a customer account identifier and a preferred mode of authentication, the customer account identifier being associated with a customer account maintained at the issuer server;
query a payment network database for a customer device identifier associated with the preferred mode of authentication and the customer account identifier, the customer device identifier being associated with a customer electronic device;
identify, using the payment network database, a device service provider server associated with the customer device identifier;
transmit, to the device service provider server, a request for authorisation to proceed with the card-not-present transaction, wherein the request for authorisation comprises at least the customer device identifier and the payment amount;
receive, from the device service provider server, a response for authorisation indicating if the card-not-present transaction is authorised; and
transmit, to the issuer server, an authentication response indicating if the card-not-present transaction is authorised to proceed or is refused.

Embodiments of the invention therefore provide a system that can be used for authenticating a card-not-present transaction. In particular, the system provides for another mode of authentication (e.g. determined by either a customer or an issuer institution) by comprising an authentication server configured to: (i) receive an authentication request from an issuer server comprising a payment amount, a customer account identifier and a preferred mode of authentication; (ii) query a payment network database for a customer device identifier associated with the preferred mode of authentication and the customer account identifier; (iii) identify, using the payment network database, a device service provider server associated with the customer device identifier; (vi) transmit a request for authorisation to the device service provider server; (v) receive a response for authorisation from the device service provider server; and (vi) transmit, to the issuer server, an authentication response indicating if the card-not-present transaction is authorised to proceed or is refused. This provides means for other mode(s) of authentication for the customer and/or issuer institution. Besides improving customer experience in providing more personal options to the customers, providing other modes for authentication also decrease costs by reducing resources used. For example, in the present invention, an authentication request can be made via a smart watch where the request can be authorised by the customer with a touch/click on the watch as compared to having the customer to retrieve his/her mobile phone and input an OTP for an online transaction in the conventional way. Moreover, the data transmitted to e.g. a smart watch, may be encrypted, thereby offering more security than a typically non-encrypted message using a SMS service.

In addition, embodiments of the invention can be carried out using present infrastructures so that minimal costs will be incurred to implement the above. The primary set-up required is to maintain profiles of customers registered to use other modes/methods for authenticating card-not-present transactions. This can be easily implemented using existing memory storages, servers and/or databases. Furthermore, the use of a SMS service incurs maintenance and infrastructure costs for the issuer institutions whereas the present invention builds on existing infrastructure which can be easily implemented via the payment gateway.

The authentication server may be configured to:
receive, from the issuer server, a mode of authentication request, the mode of authentication request being a request for a list of at least one mode of authentication registered for use in authenticating card-not-present transactions and comprises at least the customer account identifier;
retrieve, using the payment network database, the list of at least one mode of authentication associated with the customer account identifier; and
transmit, to the issuer server, a mode of authentication response comprising the list of at least one mode of authentication.

The authentication server may be configured to:
receive, from the issuer server, a preferred mode of authentication request, the preferred mode of authentication request being a request for the preferred mode of authentication and comprises at least the customer account identifier; and
transmit, to the issuer server, a preferred mode of authentication response comprising the preferred mode of authentication.

The authentication server may be configured to:
transmit a mode of authentication selection request comprising the list of at least one mode of authentication; and
receive a mode of authentication selection response comprising the preferred mode of authentication selected from the list of at least one mode of authentication.

The system may comprise a registration server comprising at least a second computer processor and a second data storage device, the second data storage device comprising instructions operative by the second computer processor to:
receive, from the device service provider server, a token provisioning request comprising the customer account identifier and the customer device identifier;
transmit, to the issuer server, a registration request comprising at least the customer account identifier and a mode of authentication associated with the customer device identifier;
receive, from the issuer server, a registration response indicating if the registration has been approved; and
transmit, to the device service provider server, a token provisioning response indicating if the token provisioning request is approved or refused, the token provisioning response comprising at least a token associated with the customer account identifier if the registration has been approved.

The registration server may be configured to transmit a transaction key to the customer electronic device via the device service provider server if the token provision request is approved.

The authentication server may be configured to encrypt at least the customer device identifier and the payment amount comprised in the request for authorisation, wherein the encrypted customer device identifier and the encrypted payment amount are decrypted by the customer electronic device using the transaction key to retrieve the request for authorisation.

The registration server may be configured to transmit registration details comprising at least the customer account identifier and the customer device identifier to the authentication server, and wherein the authentication server may be configured to store the registration details in the payment network database.

The authentication server may be configured to:
receive, from the device service provider server, registration details comprising at least the customer account identifier and the customer device identifier; and
store, in the payment network database, the registration details.

The authentication server may be configured to:
transmit, to the registration server, a request for registration details comprising at least the customer account identifier;
receive, from the registration server, a response for registration details comprising at least the customer device identifier; and
store, in the payment network database, registration details comprising at least the customer account identifier and the customer device identifier.

In accordance with a second aspect of the present invention, there is provided a computer-implemented method for authenticating a card-not-present transaction, the method comprising:
receiving, from an issuer server, an authentication request comprising a payment amount associated with the card-not-present transaction, a customer account identifier and a preferred mode of authentication, the customer account identifier being associated with a customer account maintained at the issuer server;
querying a payment network database for a customer device identifier associated with the preferred mode of authentication and the customer account identifier, the customer device identifier being associated with a customer electronic device;
identifying, using the payment network database, a device service provider server associated with the customer device identifier;
transmitting, to the device service provider server, a request for authorisation to proceed with the card-not-present transaction, wherein the request for authorisation comprises at least the customer device identifier and the payment amount;
receiving, from the device service provider server, a response for authorisation indicating if the card-not-present transaction is authorised; and
transmitting, to the issuer server, an authentication response indicating if the card-not-present transaction is authorised to proceed or is refused.

The method may comprise:
receiving, from the issuer server, a mode of authentication request, the mode of authentication request being a request for a list of at least one mode of authentication registered for use in authenticating card-not-present transactions and comprises at least the customer account identifier;
retrieving, using the payment network database, the list of at least one mode of authentication associated with the customer account identifier; and
transmitting, to the issuer server, a mode of authentication response comprising a list of at least one mode of authentication registered for use in authenticating card-not-present transactions.

The method may comprise:
receiving, from the issuer server, a preferred mode of authentication request, the preferred mode of authentication request being a request for the preferred mode of authentication and comprises at least the customer account identifier; and
transmitting, to the issuer server, a preferred mode of authentication response comprising the preferred mode of authentication.

The method may comprise:
transmitting a mode of authentication selection request comprising the list of at least one mode of authentication; and
receiving a mode of authentication selection response comprising the preferred mode of authentication selected from the list of at least one mode of authentication.

The method may comprise:
receiving, from the device service provider server, a token provisioning request comprising the customer account identifier and the customer device identifier;
transmitting, to the issuer server, a registration request comprising at least the customer account identifier and a mode of authentication associated with the customer device identifier;
receiving, from the issuer server, a registration response indicating if the registration has been approved; and
transmitting, to the device service provider server, a token provisioning response indicating if the token provisioning request is approved or refused, the token provisioning response comprising at least a token associated with the customer account identifier if the registration has been approved.

The method may comprise:
transmitting, to the customer electronic device via the device service provider server, a transaction key if the token provision request is approved.

The method may comprise:
encrypting at least the customer device identifier and the payment amount comprised in the request for authorisation;
wherein the encrypted customer device identifier and the encrypted payment amount are decrypted by the customer electronic device using the transaction key to retrieve the request for authorisation.

The method may comprise:
receiving, from the device service provider server, registration details comprising at least the customer account identifier and the customer device identifier; and
storing, in the payment network database, the registration details.

The request for authorisation may comprise a request to verify at least one of the following: a biometric, a personal identification number (PIN), a pattern, and a gesture or a device key.

In accordance with a third aspect of the present invention, a non-transitory computer-readable medium having stored thereon program instructions for causing at least one processor to perform the preceding method.

The present invention aims to provide a new and useful computer system and computer-implemented method for authenticating a card-not-present transaction to enhance customer experience by providing other modes/methods for authentication.

### BRIEF DESCRIPTION OF THE DRAWINGS

Non-limiting embodiments of the invention will now be described for the sake of example only, with reference to the following drawings in which:

FIG. 1 shows a computer system for authenticating a card-not-present transaction in accordance with an embodiment of the invention;

FIG. 2 shows steps of a method for authenticating a card-not-present transaction in accordance with an embodiment of the invention;

FIG. 3 shows steps of a method for providing a list of at least one mode of authentication for authenticating a card-not-present transaction in accordance with an embodiment of the invention;

FIG. 4 shows steps of a method for providing a preferred mode of authentication for authenticating a card-not-present transaction in accordance with an embodiment of the invention;

FIG. 5 shows steps of a method for providing a preferred mode of authentication for authenticating a card-not-present transaction in accordance with an embodiment of the invention;

FIG. 6 shows steps of a method for registering a customer electronic device for authenticating a card-not-present transaction in accordance with an embodiment of the invention;

FIG. 7 shows steps of a method for storing registration details for authenticating a card-not-present transaction in accordance with an embodiment of the invention;

FIG. 8 shows steps of a method for storing registration details for authenticating a card-not-present transaction in accordance with an embodiment of the invention;

FIG. 9 shows steps of a method for requesting registration details for authenticating a card-not-present transaction in accordance with an embodiment of the invention; and

FIG. 10 shows schematically a hardware structure of a server which may be used in the computer system of FIG. 1 to implement a method in accordance with an embodiment of the invention.

### DETAILED DESCRIPTION OF THE EMBODIMENT

As used in this document, the term “card-not-present transaction” refers to any form of transaction which does not require the physical presence of a payment card in order to complete the transaction. It includes, non-exhaustively, an e-commerce transaction, an electronic fund transfer, and any form of electronic/online payment (e.g. an electronic bill payment etc.) or transaction (e.g. an electronic trading transaction etc.).

The term “account” refers to any payment account which may hold funds such as a saving account, a current account, a checking account or any account associated with a payment card.

Note that the term “payment card” refers to any electronic cashless payment vehicle associated with a payment account, such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, transponder devices, NFC-enabled devices, and/or computers.

Note that the term “institution” is used here in a sense which is not necessarily limited to organizations which are legally constituted as banks, since in some jurisdictions other organizations may be permitted to maintain financial accounts such as a payment card account. An institution may be one of the following: a bank, a financial technology company, a telecommunication company or a financial institution.

As used in this application, the terms “component,” “module,” “system,” “apparatus,” “interface,” or the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component or a module. One or more components/modules may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

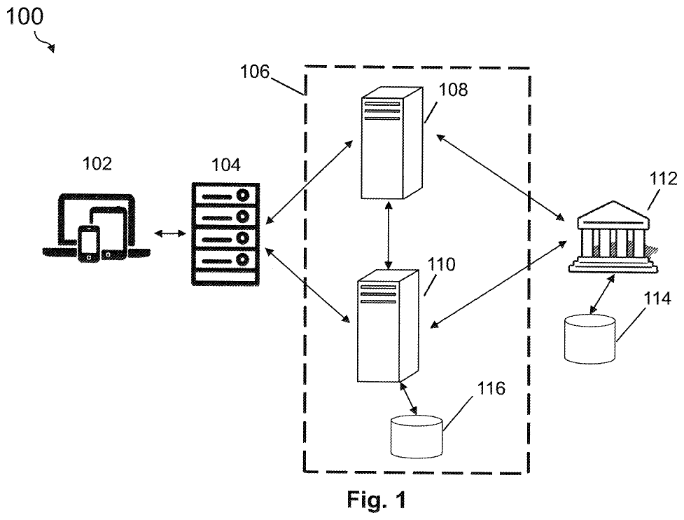

FIG. 1 shows a computer system 100 in accordance with an embodiment of the invention. The computer system 100 includes a payment network such as the Banknet payment network operated by Mastercard. The computer system 100 comprises a payment network system 106 operated by the payment network. The payment network system 106 comprises a registration server 108 and an authentication server 110. For clarity, the present description focuses on the authentication function of the payment network system 106, but the payment network system 106 may also be capable of processing and facilitating payments for card-not-present transactions and other forms of transactions (e.g. point-of-sale (POS) transactions). The payment network system 106 is in communication with a device service provider server 104 and an issuer server 112. In particular, as shown in FIG. 1, the registration server 108 and the authentication server 110 of the payment network system 106 are each in communication with the device service provider server 104 and the issuer server 112. The registration server 108 and the authentication server 110 of the payment network system 106 may also be in communication with each other. The device service provider server 104 is operated by a service provider associated with a customer electronic device 102. The service provider may be a manufacturer of the customer electronic device 102 or a third-party capable of providing service (e.g. transmission of data or application updates etc.) to the customer electronic device 102. The issuer server 112 is associated with an issuer institution which issues at least a payment card and/or maintains a customer account that can be used for payment in a card-not-present transaction.

As shown in FIG. 1, the customer electronic device 102 is in communication with the device service provider sever 104. The customer electronic device 102 is any electronic device which enables the customer to authenticate a card-not-present transaction. The customer electronic device 102 may be a mobile phone, a laptop, a notebook, a desktop, a tablet, a personal digital assistant (PDA), a key fob, a transponder device, a smart watch, a NFC-enabled device, and/or a computer. The computer system 100 further comprises an issuer database 114 which is operationally connected to the issuer server 112. The issuer database 114 serves at least to store data related to details of a payment card or a customer account associated with the customer and issued by the issuer institution. The issuer database 114 may store a pre-defined priority for the preferred mode of authentication for the customer to use for card-not-present transactions. The pre-defined priority may be pre-determined by either the issuer server 112 or the customer. The computer system 100 may comprise a payment network database 116 which is operationally connected to the authentication server 110. The payment network database 116 may store data related to a customer device identifier, a preferred mode of authentication and a customer account identifier. In some embodiments, the payment network database 116 stores the pre-defined priority for the preferred mode of authentication. In this case, when processing authentication for a card-not-present transaction, the issuer server 112 is configured to query the authentication server 110 for the pre-defined priority to identify the preferred mode of authentication. In an event where the pre-defined priority for the preferred mode of authentication is absent, the issuer server 112 may resort to a default mode of authentication as determined by the issuer server 112 (e.g. authenticating using a one-time-password transmitted via a SMS). The customer device identifier is uniquely associated with the customer electronic device 102 and may comprise at least one of the following: a device serial number, an international mobile equipment identity (IMEI) number, a mobile equipment identifier (MEID), an integrated circuit card identifier (ICCID) and a unique device name. The preferred mode of authentication is associated with a preferred method of transmitting an authentication request to the customer for authorising a card-not-present transaction. The preferred mode of authentication may include one of the following: a mobile phone, a smart watch, a smart glass or spectacle or any form of smart accessories which is capable of wireless or wired data transmission, a tablet, a laptop, a notebook, a PDA and a computer. The customer account identifier is associated with the payment card or the customer account maintained by the issuer institution and may include one of the following: a customer name, an account number, a payment card number and a customer identification number. The payment network database 116 may store information associated with the device service provider server 104 in relation to the customer device identifier (e.g. a name of the device service provider, an internet protocol (IP) address of the device service provider server etc.), as well as registration details comprising at least the customer account identifier and the customer device identifier.

The present invention aims to build upon present infrastructures for authenticating a card-not-present transaction. In particular, the present invention is compatible with either the 3DS 1.0 or the 3DS 2.0 procedures. Typically, upon making a card-not-present transaction request at a merchant website, the transaction request is forwarded by a merchant server, via an acquirer server, to the issuer server 112 for authorisation. The merchant server is associated with the merchant website, while the acquirer server is associated with an acquirer institution which maintains a merchant account to receive funds for payment transactions. Conventionally, once the issuer server 112 has received the request for authorisation, the issuer server is configured to request authentication from a customer, typically via a customer electronic device 102 and using an OTP. The issuer server 112 authorises the card-not-present transaction upon receiving a matching OTP from the customer electronic device 102 which authenticates the transaction request.

In the present invention, for authenticating a card-not-present transaction, the issuer server 112 is configured to transmit an authentication request to the authentication server 110, where a request for authorisation is subsequently transmitted by the authentication server 110 to the customer electronic device 102 (via the device service provider server 104) associated with the preferred mode of authentication for authorisation. In this way, the computer system 100 provides another mode of authentication that improves customer experience by providing more personal options to the customers.

In particular, the authentication server 110 is configured to receive an authentication request comprising a payment amount associated with the card-not-present transaction, a customer account identifier and a preferred mode of authentication from the issuer server 112. The customer account identifier is associated with a customer account or a customer payment card maintained at the issuer server 112, while the preferred mode of authentication is a chosen method of authenticating the card-not-present transaction. Upon receiving the authentication request, the authentication server 110 is configured to query for a customer device identifier using the payment network database 116, where the customer device identifier is associated with the preferred mode of authentication and the customer account identifier. The authentication server 110 is configured to identify a device service provider server 104 associated with the customer device identifier using the payment network database 116, and to transmit the request for authorisation to proceed with the card-not-present transaction to the device service provider server 104. The request for authorisation comprises at least the customer device identifier and the payment amount. The request for authorisation may comprise a request to verify at least one of the following: biometric authentication (e.g. a fingerprint, a face recognition, an electrocardiogram (ECG) fingerprint, etc.), a personal identification number (PIN), a pattern, and a gesture. Such input may be entered at the customer electronic device 102 which has received the authorisation request. In some embodiments, the verification used for authorisation includes a device specific authentication mechanism. For example if the customer electronic device is a smart watch, verification of the customer may require the customer, prior to initiating a card-not-present transaction, to: (i) input a PIN only once using the smart watch; (ii) abstain from inputting the PIN again for the next 24 hours; and (iii) wear the smart watch during that 24-hour period. A specific authentication mechanism such as this may improve security for verification. In some embodiments, the customer electronic device 102 verifies the input (e.g. a biometric such as a fingerprint) by comparing the input with existing verification data stored in a device database associated with the customer electronic device 102. Also, the customer electronic device 102 may authenticate automatically without input from the customer (e.g. by performing an operation using a key stored in the device or by using an ECG sensor enabled device etc.). For example, the customer electronic device 102 can be configured to decrypt an encrypted form of a request for authorisation before sending the decrypted form back to the authentication server 110 as a form of verification. Once the customer is successfully verified and that the customer has authorised the card-not-present transaction, the customer electronic device 102 transmits a response for authorisation to the authentication server 110 via the device service provider server 104. The authentication server 110 is configured to receive the response for authorisation from the device service provider server 104, and to transmit an authentication response to the issuer server 112 indicating if the card-not-present transaction is authorised to proceed or is refused by the customer. The card-not-present transaction may then be processed by the issuer server 112 in a conventional manner to complete the transaction.

In order to determine the preferred mode of authentication for authorising a card-not-present transaction, the issuer server 112 may request a list comprising at least one mode of authentication from the authentication server 110. The authentication server 110 may be configured to receive a mode of authentication request from the issuer server 112, where the mode of authentication request comprises at least the customer account identifier. The authentication server 110 may be configured to determine if there is at least one mode of authentication associated with the customer account identifier upon receiving the mode of authentication request. If it is determined that there is at least one mode of authentication request, the authentication server 110 may be configured to retrieve, using the payment network database 116, the list of at least one mode of authentication associated with the customer account identifier, and to transmit a mode of authentication response comprising the list of at least one mode of authentication registered for use in authenticating card-not-present transactions to the issuer server 112. If it is determined that the customer has not registered at least one mode of authentication with the authentication server 110, the issuer server 112 may be configured to use a default mode of authentication for authenticating the card-not-present transaction (e.g. by using an OTP).

The issuer server 112 may be configured to determine the preferred mode of authentication for use in authenticating the card-not-present transaction upon receiving the list of at least one mode of authentication from the authentication server 110. The preferred mode of authentication may be identified based on a pre-defined priority which may be pre-determined by the issuer server 112 or by the customer when the customer registered to authenticate card-not-present transactions using another mode of authentication. The pre-defined priority for the preferred mode of authentication, associated with either the issuer server 112 or the customer, may be stored in the issuer database 114. In some embodiments where the issuer server 112 does not have direct access to the preferred mode of authentication, it may be necessary for the issuer server 112 to request the preferred mode of authentication from the authentication server 110. The issuer server 112 may do so with or without acquiring the list of at least one mode of authentication from the authentication server 110 as described above. The authentication server 110 may be configured to receive a preferred mode of authentication request comprising at least the customer account identifier from the issuer server 112, and to transmit a mode of authentication selection request comprising the preferred mode of authentication to the issuer server 112. The preferred mode of authentication may either be stored in the payment network database 116 (e.g. when the customer registers with the payment network system 106) or it may be requested from the customer (e.g. via a same means through which the customer has initiated the card-not-present transaction). In the latter case, the authentication server 110 may be configured to transmit a mode of authentication selection request comprising the list of at least one mode of authentication to the customer, and to receive a mode of authentication selection response comprising the preferred mode of authentication selected from the list of at least one mode of authentication from the customer. In some embodiments, the preferred mode of authentication may be requested via a different means through which the customer has initiated the card-not-present transaction (e.g. via another mode of communication pre-determined by the customer or the issuer for this type of transaction). This may provide additional security for the card-not-present transaction as information for processing the card-not-present transaction is transmitted to the customer via different communication means thereby minimising the probability that a hacker can intercept all relevant information to commit a fraudulent transaction. In some embodiments, options are provided to the customer to change the preferred mode of authentication which he/she has previously selected from the list of at least one mode of authentication. In these cases, the authentication server 110 may be configured to transmit the mode of authentication selection request to the customer more than once, and until the preferred mode of authentication has been confirmed (e.g. through a confirmation page) by the customer before initiating the authentication process of the card-not-present transaction.

To use another mode of authentication for authenticating a card-not-present transaction, it may be necessary for the customer to be registered with the registration server 108 prior to initiating the card-not-present transaction. The registration server 108 is configured to manage registration of other modes of authentication by the customer. In particular, in order for a mode of authentication to be registered, a payment card or an account associated with the mode of authentication may need to be tokenised by the registration server 108. The registration server 108 may be configured to: (i) receive a token provisioning request comprising the customer account identifier and the customer device identifier from the device service provider server 104; (ii) transmit a registration request comprising at least the customer account identifier and a mode of authentication associated with the customer device identifier to the issuer server 112; (iii) receive a registration response indicating if the registration has been approved from the issuer server 112; and (iv) transmit a token provisioning response indicating if the token provisioning request is approved or refused to the device service provider server 104, where the token provisioning response comprises at least a token associated with the customer account identifier if the registration has been approved.

To enhance security for a card-not-present transaction, the registration server 108 may be configured to transmit a transaction key to the customer electronic device 102 via the device service provider server 104 if the token provision request is approved during registration. The transaction key may be used to encrypt or decrypt information, and it may be in the form of a symmetric key or an asymmetric key pair. When a request for authentication of a card-not-present transaction is received from the issuer server 112, the authentication server 110 may be configured to encrypt at least the customer device identifier and the payment amount comprised in the request. The encrypted customer device identifier and the encrypted payment amount may be subsequently decrypted by the customer electronic device 102 using the transaction key to retrieve the request for authorisation. This serves to prevent fraudulent transactions since the encrypted customer device identifier and the encrypted payment amount may not be accessed by any unauthorised party except through the use of the transaction key provided to the customer electronic device 102 during registration.

The registration details may comprise at least the customer account identifier and the customer device identifier. The registration details may also comprise details of the device service provider and/or the device service provider server 104 associated with the customer device identifier. Provision of the registration details to the authentication server 110 may be carried out in either one of the following ways: (i) the registration details are transmitted to the authentication server 110 by the registration server 108, or (ii) the registration details are transmitted to the authentication server 110 by the device service provider server 104. In some embodiments, the authentication server 110 is configured to request the registration details from the registration server 108 (e.g. during processing of a card-not-present transaction). In this case, the authentication server 110 may be configured to: (i) transmit, to the registration server 108, a request for registration details comprising at least the customer account identifier and; (ii) receive a response for the registration details comprising the customer device identifier from the registration server 108. In all these cases, the authentication server 110 may be configured to store the registration details received in the payment network database 116.

Although only one customer electronic device 102 and only one device service provider server 104 is shown in FIG. 1, a plurality of customer electronic devices 102 and a plurality of device service provider servers 104 associated with respective customer electronic devices may also form part of the computer system 100. Similarly, a plurality of issuer servers 112 may also be in communication with the registration server 108 and the authentication server 110 of the payment network system 106 and form part of the computer system 100. Communication between the customer electronic device 102, servers 104, 108, 110, 112 and databases 114, 116 may take place via any type of communication system, for example, a virtual private system (VPN), the Internet, a local area and/or wide area system (LAN and/or WAN), and so on.

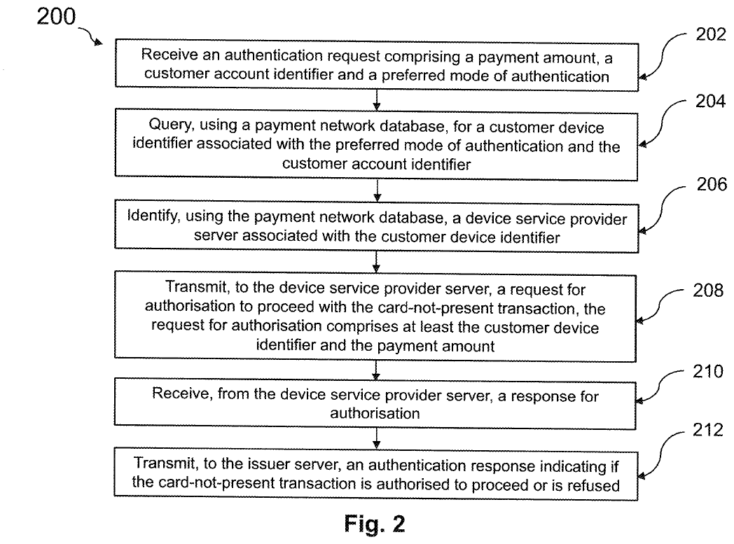

FIG. 2 shows steps of a method 200 for authenticating a card-not-present transaction in accordance with an embodiment of the invention. The method 200 may be carried out using the authentication server 110 of the payment network system 106 as shown in FIG. 1.

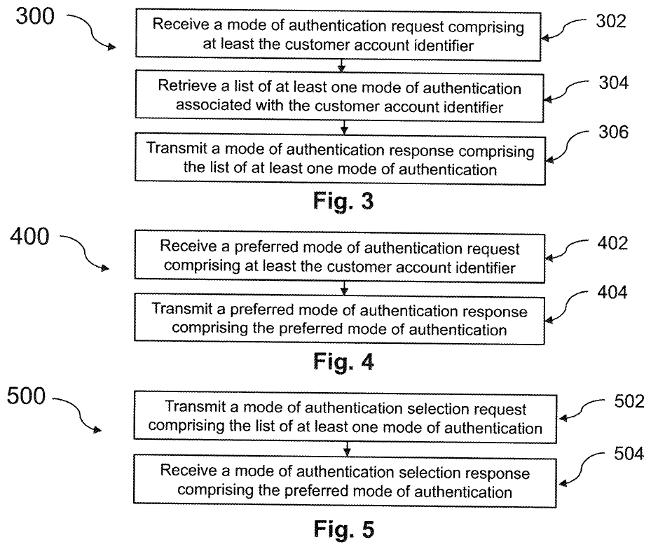

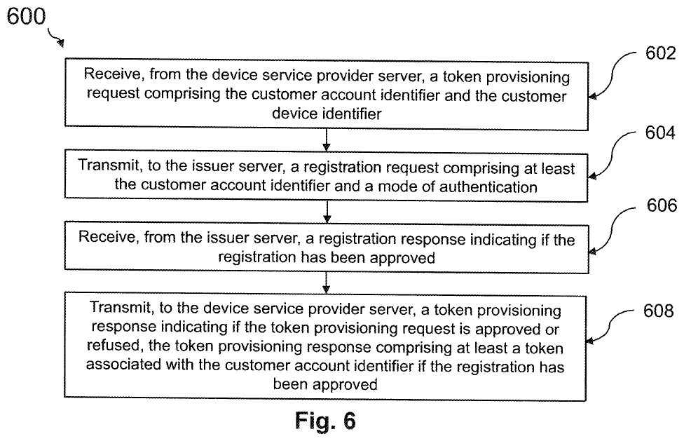

In a step 202, the authentication server 110 is configured to receive an authentication request from the issuer server 112. The authentication request comprises a payment amount, a customer account identifier and a preferred mode of authentication. The payment amount is a monetary amount required from the customer in exchange for goods or services offered by the merchant in the card-not-present transaction. The customer account identifier is a unique identifier which enables the issuer server 112 to identify at least a customer account or a customer payment card used for payment in the card-not-present transaction. The customer account identifier may be associated with one or more modes of authentication and/or one or more customer device identifiers. The customer account identifier may be one of the following: a bank account number, a payment card number, a name of the customer or the like. The customer account identifier may be comprised in registration details which are transmitted to the registration server 108 when the customer registers to use other modes of authentication for authenticating card-not-present transactions (see e.g. FIGS. 6 to 8 for more details). The preferred mode of authentication is associated with a preferred method of transmitting an authentication request to the customer for authorising a card-not-present transaction. More details on how the issuer server 112 obtains the preferred mode of authentication is discussed below in relation to FIGS. 3 to 5. The preferred mode of authentication may include one of the following: a mobile phone, a smart watch, smart glasses, or any form of smart accessories which is capable of wireless or wired data transmission, a tablet, a laptop, a PDA and a computer.

In a step 204, the authentication server 110 is configured to query for a customer device identifier, associated with the preferred mode of authentication and the customer account identifier, using the payment network database 116. The customer device identifier may be determined via its association with the preferred mode of authentication and the customer account identifier which are stored in the payment network database 116 during registration of the customer. The customer device identifier is associated uniquely with a customer electronic device 102 and may comprise at least one of the following: a device serial number, an international mobile equipment identity (IMEI) number, a mobile equipment identifier (MEID), an integrated circuit card identifier (ICCID) and a unique device name. In some embodiments, the customer account identifier is associated with more than one customer device identifiers. It may therefore be necessary for the authentication server 110 to identify the customer device identifier associated with the preferred mode of authentication. In some embodiments where the customer device identifier may be associated with only one customer device identifier, it may not be necessary for the authentication server 110 to receive information related to the preferred mode of authentication. The issuer server 112 may assess whether a customer account identifier is associated with more than one mode of authentication by (i) requesting related information from the authentication server 110, or (ii) retrieving this information from the issuer database 114 (e.g. this information may have been stored at the issuer database 114 at the time of registering the customer).

In a step 206, the authentication server 110 is configured to identify a device service provider server 104 associated with the customer device identifier using the payment network database 116. The device service provider server 104 is associated with a device service provider associated with the customer electronic device 102. The device service provider may be a manufacturer of the customer electronic device 102 or a third-party capable of providing service to the customer electronic device 102 (e.g. transmission of data or application updates etc.). Information relating the device service provider server 104 to the customer device identifier may be provided at the time of registering the customer. In some embodiments, similar information may be provided to the authentication server 110 when the device service provider participates in providing means for authenticating card-not-present transactions with the payment network system 106 (e.g. when device service providers register with the payment network system 106). Registration of device service providers may be carried out in conventional methods known to a skilled person in the art.

In a step 208, the authentication server 110 is configured to transmit, to the device service provider server 104, a request for authorisation to proceed with the card-not-present transaction. The request for authorisation comprises at least the customer device identifier and the payment amount. The request for authorisation may comprise a request to verify at least one of the following: a biometric, a personal identification number (PIN), a pattern, and a gesture or a device/transaction key. A verification input may be entered in the customer electronic device 102 which has received the authorisation request. In some embodiments, the customer electronic device 102 verifies the verification input (e.g. a biometric such as a fingerprint) using existing verification data stored in a device database of the customer electronic device 102. Once the customer is successfully verified, the customer electronic device 102 transmits a response for authorisation to the authentication server 110 via the device service provider server 104.

In a step 210, the authentication server 110 is configured to receive, from the device service provider server 104, a response for authorisation indicating if the card-not-present transaction is authorised.

Once the authentication server 110 has received the response for authorisation in the step 210, the authentication server 110 is configured to transmit, to the issuer server 112, an authentication response indicating if the card-not-present transaction is authorised to proceed or is refused in a step 212. The issuer server 112 may subsequently process the card-not-present transaction in a conventional way to either complete or refuse the card-not-present transaction.

In order to determine the preferred mode of authentication for authenticating a card-not-present transaction, the issuer server 112 may request a list comprising at least one mode of authentication from the authentication server 110. FIG. 3 shows steps of a method 300 for providing, by the authentication server 110 to the issuer server 112, a list of at least one mode of authentication for authenticating a card-not-present transaction in accordance with an embodiment of the invention.

In a step 302, the authentication server 110 is configured to receive, from the issuer server 112, a mode of authentication request. The mode of authentication request is a request for a list of at least one mode of authentication registered for use in authenticating card-not-present transactions and comprises at least the customer account identifier. Upon receiving the mode of authentication request from the issuer server 112, the authentication server 110 may be configured to retrieve a list of at least one mode of authentication registered for use in authenticating card-not-present transactions. In some embodiments, the authentication server 110 is configured to determine if there is at least one mode of authentication associated with the customer account identifier upon receiving the mode of authentication request.

Upon receiving the mode of authentication request from the issuer server 112, the authentication server 110 is configured to retrieve the list of at least one mode of authentication registered for use in authenticating card-not-present transactions using the payment network database 116 in a step 304.

In a step 306, the authentication server 110 is configured to transmit, to the issuer server 112, the mode of authentication response comprising the list of at least one mode of authentication registered for use in authenticating card-not-present transactions. In some embodiments, the authentication server 110 is configured to retrieve the list of at least one mode of authentication and to transmit the mode of authentication response to the issuer server 112 if it is determined that there is at least one mode of authentication associated with the customer account identifier. The issuer server 112 may be configured to use a default mode of authentication for authentication the card-not-present transaction (e.g. by using an OTP). In some embodiments, the authentication server 110 is configured to retrieve the list of at least one mode of authentication and to transmit the mode of authentication response to the issuer server 112 without determining if the customer account identifier is associated with at least one mode of authentication.

Upon receiving the list of at least one mode of authentication from the authentication server 110 via the method 300, the issuer server 112 may be configured to determine a preferred mode of authentication for use in authenticating the card-not-present transaction. The preferred mode of authentication may be established based on a pre-defined priority pre-determined by the issuer server 112 or by the customer (e.g. the pre-defined priority may be provided when the customer registered to authenticate card-not-present transactions using another mode of authentication). The pre-defined priority for the preferred mode of authentication, associated with either the issuer server 112 or the customer, may be stored in an issuer database 114.

In some embodiments where the issuer server 112 does not have direct access to the preferred mode of authentication, it may be necessary for the issuer server 112 to request the preferred mode of authentication from the authentication server 110. FIGS. 4 and 5 show steps of a method 400 and a method 500 respectively for providing, to the issuer server 112 by the authentication server 110, the preferred mode of authentication for authenticating a card-not-present transaction in accordance with embodiments of the invention.

Referring to FIG. 4, in a step 402, the authentication server 110 is configured to receive, from the issuer server 112, a preferred mode of authentication request. The preferred mode of authentication request is a request for the preferred mode of authentication and comprises at least the customer account identifier. The preferred mode of authentication may be stored in the payment network database 116 (e.g. when the customer registered with the payment network system 106). If the preferred mode of authentication is stored in the payment network database 116, the authentication server 110 may be configured to retrieve the preferred mode of authentication using the payment network database 116 upon receiving the preferred mode of authentication request.

In a step 404, the authentication server 110 is configured to transmit, to the issuer server 112, a preferred mode of authentication response comprising the preferred mode of authentication.

In some embodiments, if only one mode of authentication is registered, this mode of authentication is the preferred mode. In other embodiments, if there is no available registered mode of authentication or if there is more than one registered mode of authentication, and that there is no pre-defined priority for the preferred mode of authentication (e.g. no preferred mode of authentication is predetermined by the customer or the issuer server), the preferred mode of authentication may be requested from the customer during the card-not-present transaction. Referring to FIG. 5, in a step 502, the authentication server 110 is configured to transmit, to the customer, a mode of authentication selection request comprising the list of at least one mode of authentication. In some embodiments, the mode of authentication selection request is transmitted to the customer via the same means through which the customer has initiated the card-not-present transaction (e.g. a computer or a laptop). This may be achieved by transmitting the mode of authentication selection request to the customer via the issuer server 112. In some embodiments, the preferred mode of authentication may be requested via a different means through which the customer has initiated the card-not-present transaction (e.g. via another mode of communication pre-determined by the customer or the issuer for this type of transaction). This may provide additional security for the card-not-present transaction as information for processing the card-not-present transaction is transmitted to the customer via different communication means thereby minimising the probability that a hacker can intercept all relevant information to commit a fraudulent transaction.

In the step 504, the authentication server 110 is configured to receive, from the customer, a mode of authentication selection response comprising the preferred mode of authentication selected from the list of at least one mode of authentication. Upon receiving the preferred mode of authentication, the authentication server 110 may be configured to transmit the preferred mode of authentication to the issuer server 112 (e.g. in using the step 404).

FIG. 6 shows steps of a method 600 for registering a customer electronic device 102 for authenticating a card-not-present transaction. The method 600 may be carried out by the registration server 108 as shown in FIG. 1.

Referring to FIG. 6, in a step 602, the registration server 108 is configured to receive, from the device service provider server 104, a token provisioning request comprising the customer account identifier and the customer device identifier. The token provision request is a request associated with tokenisation of details of a customer payment card or a customer account, where the token may be subsequently stored in the customer electronic device 102 for making payments in card-not-present transactions. The token generated by the registration server 108 may be uniquely associated with the customer electronic device 102 or the customer device identifier. The token provisioning request may comprise details of the customer account or the customer payment card. Details of the customer account or the customer payment card may comprise a customer account number or a customer payment card number, a name of the customer, and/or details of the issuer institution associated with the customer account or the customer payment card such as bank identification code (BIC) or a SWIFT code.

In a step 604, the registration server 108 is configured to transmit, to the issuer server 112, a registration request comprising at least the customer account identifier and a mode of authentication associated with the customer device identifier. In some embodiments, the registration server 108 may be configured to communicate with the issuer server 112 associated with the customer account or the customer payment card so as to verify the details associated with the customer account or the customer payment card.

In a step 606, the registration server 108 is configured to receive, from the issuer server 112, a registration response indicating if the registration has been approved.

In a step 608, the registration server 108 is configured to transmit, to the device service provider server, a token provisioning response indicating if the token provisioning request is approved or refused. The token provisioning response may comprise at least a token associated with the customer account identifier if the registration has been approved. The token may be processed and provided by the registration server 108 in a conventional way as understood by a skilled person in the art.

In some embodiments, the registration server 108 is configured to transmit a transaction key to the customer electronic device 102 via the device service provider server 104 if the token provision request is approved. When a request for authentication of a card-not-present transaction is received from the issuer server 112, the authentication server 110 may be configured to encrypt at least the customer device identifier and the payment amount comprised in the request. The encrypted customer device identifier and the encrypted payment amount may be subsequently decrypted by the customer electronic device 102 using the transaction key to retrieve the request for authorisation. This serves to prevent fraudulent transactions since the encrypted customer device identifier and the encrypted payment amount may not be accessed by any unauthorised party except through the use of the transaction key provided to the customer electronic device 102 during registration.

In order for the authentication server 110 to carry out the methods 200 to 500 as described above, registration details received during the registration of the customer electronic device 102 in the method 600 may be provided to the authentication server 110.

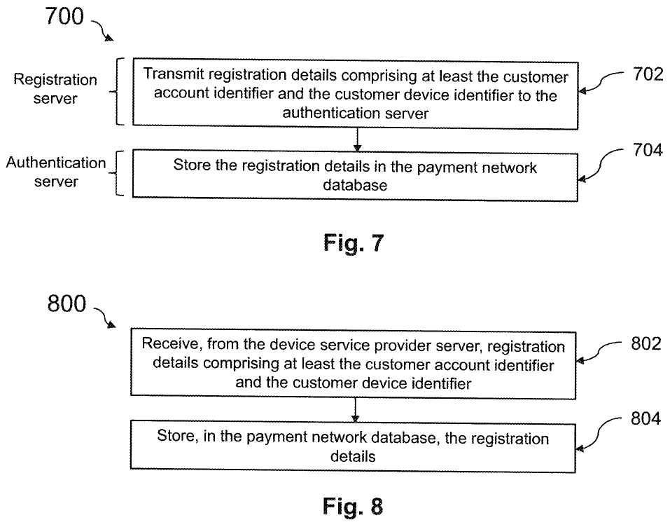

FIGS. 7 and 8 show two different embodiments (i.e. a method 700 and a method 800 respectively) for providing the authentication server 110 with registration details used in authenticating a card-not-present transaction. The method 700 is carried out by both the registration server 108 and the authentication server 110 while the method 800 is carried out by the authentication server 110.

Referring to FIG. 7, in a step 702, the registration server 108 is configured to transmit registration details comprising at least the customer account identifier and the customer device identifier to the authentication server 110.

In a step 704, the authentication server 110 is configured to store the registration details in the payment network database 116.

Referring to FIG. 8, in a step 802, the authentication server 110 is configured to receive, from the device service provider server 104, registration details comprising at least the customer account identifier and the customer device identifier.

In a step 804, the authentication server 110 is configured to store the registration details in the payment network database 116.

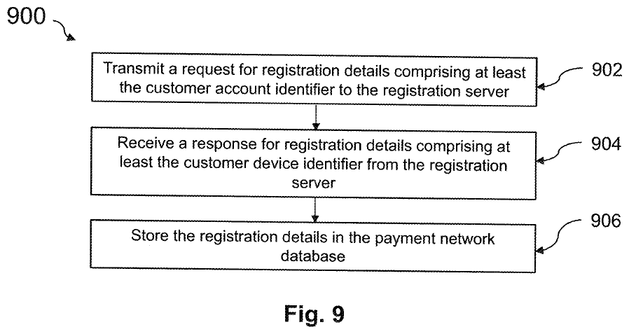

FIG. 9 shows steps of a method 900 for requesting registration details for authenticating a card-not-present transaction in accordance with an embodiment of the invention. The method 900 may be carried out by the authentication server 110 during processing of a card-not-present transaction.

In a step 902, the authentication server 110 is configured to transmit a request for registration details comprising at least the customer account identifier to the registration server 108.

In a step 904, the authentication server 110 is configured to receive a response for registration details comprising at least the customer device identifier from the registration server 108.

In a step 906, the authentication server 110 is configured to store the registration details in the payment network database 116. The registration details may comprise at least the customer account identifier and the customer device identifier.

In the present invention, the registration server 108 and the authentication server 110 may be separate or combined (i.e. a single server may operate as both the authentication server 110 and the registration server 108).

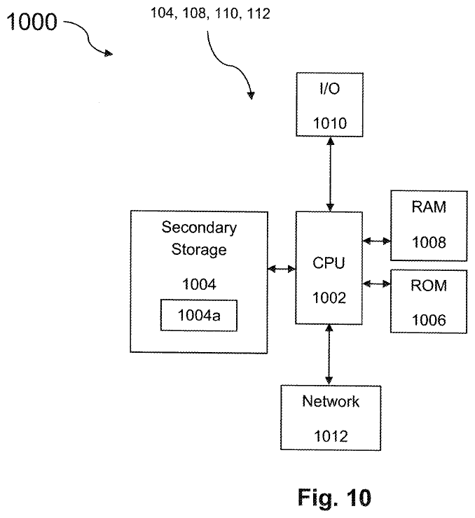

FIG. 10 is a block diagram showing a technical architecture of the registration server 108 and the authentication server 110. The issuer server 112 and/or the device service provider server 104 may also have this technical architecture.

The technical architecture includes a processor 1002 (which may be referred to as a central processor unit or CPU) that is in communication with memory devices including secondary storage 1004 (such as disk drives), read only memory (ROM) 1006, and random access memory (RAM) 1008. The processor 1002 may be implemented as one or more CPU chips. The technical architecture may further comprise input/output (I/O) devices 1010, and system connectivity devices or a network 1012.

The secondary storage 1004 is typically comprised of one or more disk drives or tape drives and is used for non-volatile storage of data and as an over-flow data storage device if RAM 1008 is not large enough to hold all working data. Secondary storage 1004 may be used to store programs which are loaded into RAM 1008 when such programs are selected for execution.

In this embodiment, the secondary storage 1004 has a processing component 1004a comprising non-transitory instructions operative by the processor 1002 to perform various operations of the method of the present disclosure. The ROM 1006 is used to store instructions and perhaps data which are read during program execution. The secondary storage 1004, the RAM 1008, and/or the ROM 1006 may be referred to in some contexts as computer readable storage media and/or non-transitory computer readable media.

I/O devices 1010 may include printers, video monitors, liquid crystal displays (LCDs), plasma displays, touch screen displays, keyboards, keypads, switches, dials, mice, track balls, voice recognizers, card readers, paper tape readers, or other input devices.

The system connectivity devices 1012 may take the form of modems, modem banks, Ethernet cards, universal serial bus (USB) interface cards, serial interfaces, token ring cards, fiber distributed data interface (FDDI) cards, wireless local area system (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other system devices. These system connectivity devices 1012 may enable the processor 1002 to communicate with the Internet or one or more intranets. With such a system connection, it is contemplated that the processor 1002 might receive information from the system, or might output information to the system in the course of performing the above-described method operations. Such information, which is often represented as a sequence of instructions to be executed using processor 1002, may be received from and outputted to the system, for example, in the form of a computer data signal embodied in a carrier wave.

The processor 1002 executes instructions, codes, computer programs, scripts which it accesses from hard disk, floppy disk, optical disk (these various disk based systems may all be considered secondary storage 1004), flash drive, ROM 1006, RAM 1008, or the system connectivity devices 1012. While only one processor 1002 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing an application and/or applications in a cloud computing environment. Cloud computing may comprise providing computing services via a system connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 1002, the RAM 1008, and the ROM 1006 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

1. A payment network system for authenticating a card-not-present transaction, the system comprising:
an authentication server comprising at least a first computer processor and a first data storage device, the first data storage device comprising instructions operative by the first computer processor to:
receive, from an issuer server, an authentication request comprising a payment amount associated with the card-not-present transaction, a customer account identifier and a preferred mode of authentication, the customer account identifier being associated with a customer account maintained at the issuer server;
query a payment network database for a customer device identifier associated with the preferred mode of authentication and the customer account identifier, the customer device identifier being associated with a customer electronic device;
identify, using the payment network database, a device service provider server associated with the customer device identifier;
transmit, to the device service provider server, a request for authorisation to proceed with the card-not-present transaction, wherein the request for authorisation comprises at least the customer device identifier and the payment amount;
receive, from the device service provider server, a response for authorisation indicating if the card-not-present transaction is authorised; and
transmit, to the issuer server, an authentication response indicating if the card-not-present transaction is authorised to proceed or is refused.

2. The system of claim 1, wherein the authentication server is further configured to:
receive, from the issuer server, a mode of authentication request, the mode of authentication request being a request for a list of at least one mode of authentication registered for use in authenticating card-not-present transactions and comprises at least the customer account identifier;
retrieve, using the payment network database, the list of at least one mode of authentication associated with the customer account identifier; and
transmit, to the issuer server, a mode of authentication response comprising the list of at least one mode of authentication.

3. The system of claim 1, wherein the authentication server is further configured to:
receive, from the issuer server, a preferred mode of authentication request, the preferred mode of authentication request being a request for the preferred mode of authentication and comprises at least the customer account identifier; and
transmit, to the issuer server, a preferred mode of authentication response comprising the preferred mode of authentication.

4. The system of claim 2, wherein the authentication server is further configured to:
transmit a mode of authentication selection request comprising the list of at least one mode of authentication; and
receive a mode of authentication selection response comprising the preferred mode of authentication selected from the list of at least one mode of authentication.

5. The system of claim 1, further comprising a registration server comprising at least a second computer processor and a second data storage device, the second data storage device comprising instructions operative by the second computer processor to:
receive, from the device service provider server, a token provisioning request comprising the customer account identifier and the customer device identifier;
transmit, to the issuer server, a registration request comprising at least the customer account identifier and a mode of authentication associated with the customer device identifier;
receive, from the issuer server, a registration response indicating if the registration has been approved; and
transmit, to the device service provider server, a token provisioning response indicating if the token provisioning request is approved or refused, the token provisioning response comprising at least a token associated with the customer account identifier if the registration has been approved.

6. The system of claim 5, wherein the registration server is further configured to transmit a transaction key to the customer electronic device via the device service provider server if the token provision request is approved.

7. The system of claim 6, wherein the authentication server is further configured to encrypt at least the customer device identifier and the payment amount comprised in the request for authorisation, wherein the encrypted customer device identifier and the encrypted payment amount are decrypted by the customer electronic device using the transaction key to retrieve the request for authorisation.

8. The system of claim 5, wherein the registration server is further configured to transmit registration details comprising at least the customer account identifier and the customer device identifier to the authentication server, and wherein the authentication server is further configured to store the registration details in the payment network database.

9. The system of claim 5, wherein the authentication server is further configured to:
receive, from the device service provider server, registration details comprising at least the customer account identifier and the customer device identifier; and
store, in the payment network database, the registration details.

10. The system of claim 5, wherein the authentication server is further configured to:
transmit, to the registration server, a request for registration details comprising at least the customer account identifier;
receive, from the registration server, a response for registration details at least the customer device identifier; and
store, in the payment network database, registration details comprising at least the customer account identifier and the customer device identifier.

11. A computer-implemented method for authenticating a card-not-present transaction, the method comprising:
receiving, from an issuer server, an authentication request comprising a payment amount associated with the card-not-present transaction, a customer account identifier and a preferred mode of authentication, the customer account identifier being associated with a customer account maintained at the issuer server;
querying a payment network database for a customer device identifier associated with the preferred mode of authentication and the customer account identifier, the customer device identifier being associated with a customer electronic device;
identifying, using the payment network database, a device service provider server associated with the customer device identifier;
transmitting, to the device service provider server, a request for authorisation to proceed with the card-not-present transaction, wherein the request for authorisation comprises at least the customer device identifier and the payment amount;
receiving, from the device service provider server, a response for authorisation indicating if the card-not-present transaction is authorised; and
transmitting, to the issuer server, an authentication response indicating if the card-not-present transaction is authorised to proceed or is refused.

12. The method of claim 11, further comprising:
receiving, from the issuer server, a mode of authentication request, the mode of authentication request being a request for a list of at least one mode of authentication registered for use in authenticating card-not-present transactions and comprises at least the customer account identifier;
retrieving, using the payment network database, the list of at least one mode of authentication associated with the customer account identifier; and
transmitting, to the issuer server, a mode of authentication response comprising the list of at least one mode of authentication.

13. The method of claim 11, further comprising:
receiving, from the issuer server, a preferred mode of authentication request, the preferred mode of authentication request being a request for the preferred mode of authentication and comprises at least the customer account identifier; and
transmitting, to the issuer server, a preferred mode of authentication response comprising the preferred mode of authentication.

14. The method of claim 12, further comprising:
transmitting a mode of authentication selection request comprising the list of at least one mode of authentication; and
receiving a mode of authentication selection response comprising the preferred mode of authentication selected from the list of at least one mode of authentication.

15. The method of claim 11, further comprising:
receiving, from the device service provider server, a token provisioning request comprising the customer account identifier and the customer device identifier;
transmitting, to the issuer server, a registration request comprising at least the customer account identifier and a mode of authentication associated with the customer device identifier;
receiving, from the issuer server, a registration response indicating if the registration has been approved; and
transmitting, to the device service provider server, a token provisioning response indicating if the token provisioning request is approved or refused, the token provisioning response comprising at least a token associated with the customer account identifier if the registration has been approved.

16. The method of claim 15, further comprising:
transmitting, to the customer electronic device via the device service provider server, a transaction key if the token provision request is approved.

17. The method of claim 16, further comprising:
encrypting at least the customer device identifier and the payment amount comprised in the request for authorisation;
wherein the encrypted customer device identifier and the encrypted payment amount are decrypted by the customer electronic device using the transaction key to retrieve the request for authorisation.

18. The method of claim 15, further comprising:
receiving, from the device service provider server, registration details comprising at least the customer account identifier and the customer device identifier; and
storing, in the payment network database, the registration details.

19. The method of claim 11, wherein the request for authorisation comprises a request to verify at least one of the following: a biometric, a personal identification number (PIN), a pattern, and a gesture or a device key.

20. A non-transitory computer-readable medium having stored thereon program instructions for causing at least one processor to perform the method according to claim 11.
